(19) United States
(12) Patent Application Publication
(10) Pub. No.: US 2022/0197200 A1
(43) Pub. Date: Jun. 23, 2022

(54) HEATING APPARATUS AND IMAGE FORMING APPARATUS

(71) Applicant: CANON KABUSHIKI KAISHA, Tokyo (JP)

(72) Inventor: Takashi Honke, Shizuoka (JP)

(21) Appl. No.: 17/539,449

(22) Filed: Dec. 1, 2021

(30) Foreign Application Priority Data
Dec. 18, 2020 (JP) 2020-210844
Oct. 29, 2021 (JP) 2021-178381

(51) Int. Cl. G03G 15/20

(52) U.S. Cl. CPC G03G 15/2053

(57) ABSTRACT

A heating apparatus includes an endless film including a base layer and an elastic layer, a heating member, and a restricting member including a restricting surface for restricting movement of the film in a widthwise direction by receiving an end surface of the film with respect to the widthwise direction when the film is moved in the widthwise direction. The elastic layer contains a thermal-conductive filler. The base layer includes a projected portion projected from the elastic layer in the widthwise direction. The movement of the film in the widthwise direction is restricted by contact of the projected portion with the restricting surface.

### FIELD OF THE INVENTION AND RELATED ART

The present invention relates to a heating apparatus, represented by a fixing device (apparatus), for use with an image forming apparatus such as a printer, a copying machine, and a facsimile machine which use an electrophotographic type or an electrostatic recording type, and relates to the image forming apparatus including the heating apparatus.

Conventionally, for example, in the image forming apparatus of the electrophotographic type, the heating apparatus (image heating apparatus, sheet heating apparatus) represented by the fixing device for fixing an unfixed toner image, formed on a recording material, on the recording material is used. In the following, the fixing device will be described as an example.

As the fixing device, a fixing device of a film heating type has been known (Japanese Laid-Open Patent Application (JP-A) Hei 4-44075). As a representative constitution, such a fixing device includes a cylindrical film having a high heat-resistant property (hereinafter, also referred to as a “fixing film”), a ceramic heater contacting an inner surface of the fixing film (hereinafter, also simply referred to as a “heater”), and a pressing roller for pressing a nip via the fixing film in cooperation with the heater. Further, this fixing device heats the recording material carrying thereon the toner image while feeding the recording material, and fixes the toner image on the recording material. In the fixing device of the film heating type, as the heater and the fixing film, those with low thermal capacity are used, and therefore, the fixing device has an advantage such that electric power saving and shortening of a wait time (quick start) are enabled.

The fixing film is required to have a high heat-conductive property, a low thermal capacity, a parting property, durability and the like. Further, as the fixing film, a fixing film including an elastic layer has been known (JP-A 2000-187407). As a representative constitution, such a fixing film includes a resin layer or a metal layer as a base layer, an elastic layer as an intermediary layer, and a parting layer as a surface layer. The resin layer as the base layer is represented by a layer formed of polyimide. Further, the metal layer as the base layer is represented by a layer formed of a stainless (SUS). Further, the elastic layer as the intermediary layer is represented by a layer formed of a silicone rubber. Further, the parting layer as the surface layer is represented by a layer formed of a fluorine-containing resin material. The fixing film is provided with the elastic layer, whereby improvement in image quality can be realized by imparting heat uniformly to the toner image so as to wrap the toner image. Here, the silicone rubber layer as the elastic layer is small in thermal-conductive property by itself. For this reason, a thermal-conductive filler is contained in the silicone rubber layer, so that a high thermal-conductive property is imparted to the silicone rubber layer. As a representative material of the thermal-conductive filler, it is possible to cite alumina, metal silicon, silicon carbide, and the like.

On the other hand, in the fixing device of the film heating type, there is a case that a shift movement of the fixing film toward a widthwise direction substantially perpendicular to a circumferential direction (surface movement direction) of the fixing film during rotation of the fixing film occurs. Therefore, a restricting member (hereinafter, referred to as a “flange”) for suppressing shift movement of the fixing film in contact with an end portion of the fixing film with respect to the widthwise direction is provided adjacent to the end portion of the fixing film with respect to the widthwise direction.

Incidentally, in this technical field, in recent years, speed-up and lifetime elongation have been strongly required. In the fixing film, there is a problem such that the speed-up and the lifetime elongation are compatibly realized. Specifically, in order to meet the speed-up, realization of high thermal conductivity of the fixing film is required. In order to realize the high thermal conductivity, it is effective that an amount of the thermal-conductive filler contained in the elastic layer is increased. However, for example, in the case where the amount of the thermal-conductive filler contained in the elastic layer is increased in this way or in the like case, abrasion (wearing) of the base layer of the fixing film is liable to occur in some instances. As a result, buckling of the fixing film at an end portion with respect to the widthwise direction is liable to occur, so that there is a possibility that the occurrence of the buckling prevents the lifetime elongation.

As specifically described later, it turned out that the above-described abrasion is promoted by abrasion of the base layer by the above-described thermal-conductive filler which is abraded from an end surface of the elastic layer and which is then interposed between the fixing film and the flange.

### SUMMARY OF THE INVENTION

Accordingly, a principal object of the present invention is to provide a heating apparatus and an image forming apparatus which are capable of realizing lifetime elongation by suppressing abrasion of a film including an elastic layer containing a thermal-conductive filler.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of a fixing device.

Part (a) of FIG. 3 is a schematic side view of the fixing device, and part (b) of FIG. 3 is a schematic front view of a flange.

Parts (a) and (b) of FIG. 4 are sectional side views of the neighborhood of a flange for illustrating a conventional problem.

Part (a) of FIG. 5 is a schematic sectional view of a fixing film in a fixing device of an embodiment 1, and part (b) of FIG. 5 is a sectional side view of the neighborhood of a flange in the fixing device of the embodiment 1.

FIG. 6 is a sectional side view of the neighborhood of an end portion in the fixing device of the embodiment 1.

Parts (a) and (b) of FIG. 7 are sectional side views of fixing films in fixing devices of comparison examples 1 and 2, respectively.

FIG. 8 is a schematic sectional side view of the neighborhood of the flange for illustrating a conventional problem.

Parts (a) and (b) of FIG. 9 are schematic sectional side views of the neighborhoods of flanges in fixing devices of an embodiment 2 and a modified embodiment thereof, respectively.

Parts (a) to (d) of FIG. 10 are schematic sectional views of fixing films of an embodiment 3.

Parts (a), (b) and (c) of FIG. 11 are schematic sectional side views of the neighborhoods of an end portion in a fixing device of the embodiment 3.

### DESCRIPTION OF THE EMBODIMENTS

In the following, a heating apparatus and an image forming apparatus according to the present invention will be specifically described with reference to the drawings.

### Embodiment 1

### 1. Constitution and Operation of Image Forming Apparatus

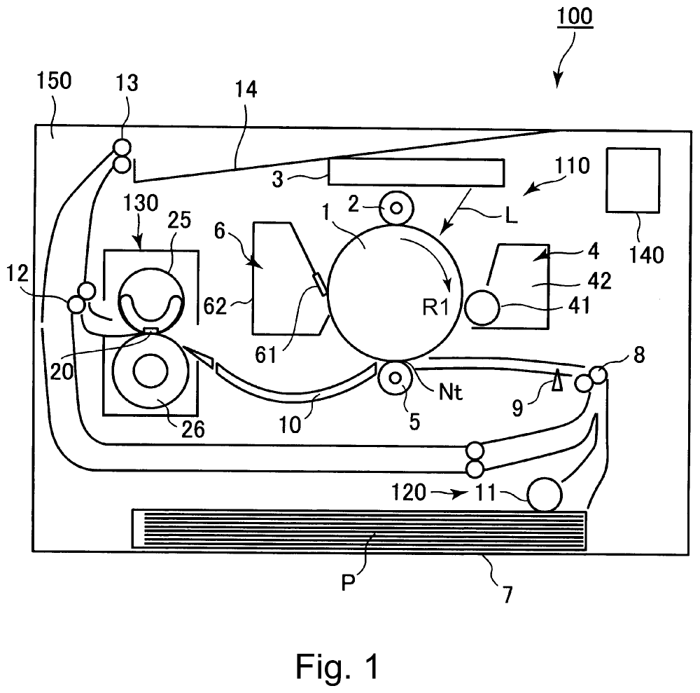

FIG. 1 is a sectional side view (cross section substantially perpendicular to a rotational axis direction of a photosensitive drum 1 described later) of an image forming apparatus 100 of this embodiment. In this embodiment, the image forming apparatus 100 is a laser beam printer of an electrophotographic type.

The image forming apparatus 100 includes an image forming portion 110 for forming a toner image on a recording material P, a recording material feeding portion 120 for feeding the recording material P to the image forming portion 110, and a fixing device (fixing portion) 130 for fixing the toner image, formed on the recording material P, on the recording material P. Further, the image forming apparatus 100 includes a controller 140 as a control means for controlling the image forming portion 110, the recording material feeding portion 120, the fixing device 130, and the like. The controller 140 is constituted by including a CPU as a calculation control means, memories such as a ROM and a RAM as storing means, an input/output circuit for carrying out sending and receiving of a signal between the controller 140 and an external device (not shown), and in the memories, various programs necessary for image formation are stored. The controller 140 acquires a print signal from the external device such as a host computer and executes a predetermined image forming sequence on the basis of its print signal. The image forming portion 110, the recording material feeding portion 120, the fixing 130, the controller 140, and the like are provided inside an apparatus main assembly 150 constituting a casing of the image forming apparatus 100.

In the image forming portion, the photosensitive drum 1 which is a drum-type (cylindrical) electrophotographic photosensitive member is provided as an image bearing member. Further, in the image forming portion, around a surface (outer peripheral surface) of the photosensitive drum 1, a charging roller 2, a laser scanner 3, a developing device 4, a transfer roller 5, and a cleaning device 6 are provided.

The photosensitive drum 1 is rotationally driven at a predetermined peripheral speed (process speed) in an arrow R1 direction (clockwise direction) in FIG. 1 by a drum driving motor (not shown). A surface of the rotating photosensitive drum 1 is electrically charged uniformly to a predetermined polarity (negative in this embodiment) and a predetermined potential by the charging roller 2 which is a roller-type charging member as a charging means. During a charging process, to the charging roller 2, a predetermined charging voltage (charging bias) is applied by a charging voltage source (not shown). In this embodiment, to the charging roller 2, a charging voltage including a DC component of the negative polarity is applied. The charged surface of the photosensitive drum 1 is subjected to scanning exposure by the laser scanner (exposure device) 3 as an exposure means, so that an electrostatic latent image (electrostatic image) is formed on the photosensitive drum 1. The surface of the photosensitive drum 1 is exposed to light by scanning the photosensitive drum surface with laser light L modulated on the basis of image information. By this, an electric charge of an exposed portion of the surface of the photosensitive drum 1 is removed, so that the electrostatic latent image is formed on the photosensitive drum 1.

The electrostatic latent image formed on the photosensitive drum 1 is developed (visualized) by being supplied with toner as a developer by the developing device 4 as a developing means, so that a toner image (developer image) is formed on the photosensitive drum 1. The developing device 4 includes a developing roller 41 and a toner container 42 for accommodating the toner. The toner is rubbed with a developer regulating member (not shown) constituted by an urethane blade or the like, and thus is triboelectrically charged to a predetermined polarity (negative in this embodiment). Further, during development, to the developing roller 41, a developing voltage including a DC component of the negative polarity is applied. In this embodiment, to the developing roller 41, a developing voltage including a DC component of the negative polarity is applied. The electrostatic latent image on the photosensitive drum 1 is developed by deposition of the toner by utilizing a potential difference, due to the developing voltage, between the photosensitive drum 1 and the developing roller 41. In this embodiment, the photosensitive drum surface is uniformly charged and then is exposed to light, so that the toner charged to the same polarity as a charge polarity of the photosensitive drum 1 is deposited on an exposed portion (first portion) on the photosensitive drum 1 lowered in absolute value of the potential (reversal development). In this embodiment, a normal charge polarity of the toner which is the charge polarity of the toner during the development is the negative polarity.

Opposed to the photosensitive drum 1, the transfer roller 5 which is a roller-type transfer member as a transfer means is disposed. The transfer roller 5 is urged toward the photosensitive drum 1 and forms a transfer nip (transfer portion) Nt where the surface of the photosensitive drum 1 and the surface (outer peripheral surface) of the transfer roller 5 are in contact with each other.

The toner image formed on the photosensitive drum 1 is transferred onto the recording material C transfer(-receiving) material, sheet) P such as a recording sheet nipped and fed between the photosensitive drum 1 and the transfer roller 5. During the transfer, to the transfer roller 5, a transfer voltage (transfer bias) of an opposite polarity (positive in this embodiment) to the normal charge polarity of the toner by a transfer voltage source (not shown) is applied. The toner image on the photosensitive drum 1 is transferred onto the recording material P by utilizing a potential difference, due to the transfer voltage, between the photosensitive drum 1 and the transfer roller 5.

The recording material P is supplied to the transfer nip Nt by the recording material feeding portion 120. The recording material feeding portion 120 includes a cassette 7 as a recording material accommodating portion, a feeding roller 11 as a feeding member, and the like. The feeding roller 11 is rotationally driven at a predetermined timing by a feeding driving motor as a driving source constituting a driving means, and feeds the recording material P, to a feeding passage, stacked and accommodated in the cassette 7. This recording material P is timed to the toner image on the photosensitive drum 1 and is conveyed to the transfer nip Nt by a conveying roller 8 as a conveying member. Incidentally, in the feeding passage between the conveying roller 8 and the transfer nip Nt, a top sensor 9 as a recording material detecting means is provided. The recording material P passes through the top sensor 9 and is conveyed to the transfer portion Nt.

The recording material P on which the toner image is transferred is conveyed to the fixing device 130 along a conveying guide 10 as a conveying guide member. The fixing device 130 conveys the recording material P carrying thereon an unfixed toner while heating and pressing the recording material P, so that the toner image is fixed (melted, stuck) on the recording material P. The recording material P on which the toner image is fixed is conveyed by a conveying roller 12 as a conveying member, a discharging roller 13 as a discharging member, and the like, and then is discharged (outputted) onto a discharge tray 14 as a discharge portion provided on an upper surface of the apparatus main assembly 150.

On the other hand, toner (transfer residual toner) remaining on the surface of the photosensitive drum 1 after the toner image is transferred onto the recording material P is removed and collected from the surface of the photosensitive drum 1 by the cleaning device 6 as a cleaning means. The cleaning device 6 scribes off the transfer residual toner of the surface of the rotating photosensitive drum 1 by a cleaning blade 61 as a cleaning member contacting the surface of the photosensitive drum 1, and accommodates and accumulates the transfer residual toner in a cleaning container 62.

The image forming apparatus 100 is capable of carrying out printing at a printing rate of 70 sheets/min in the case of an A4 size.

Further, in this embodiment, the photosensitive drum 1, and as process means actable thereon, the charging roller 2, the developing device 4 and the cleaning device 6 integrally constitute a process cartridge detachably mountable to the apparatus main assembly 150.

### 2. Fixing Device

### <General Structure of Fixing Device>

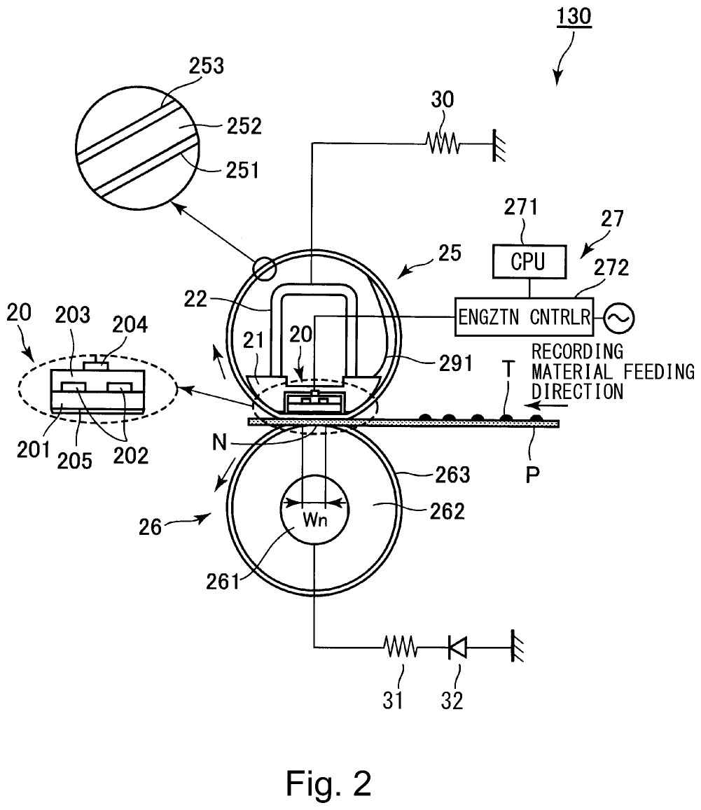

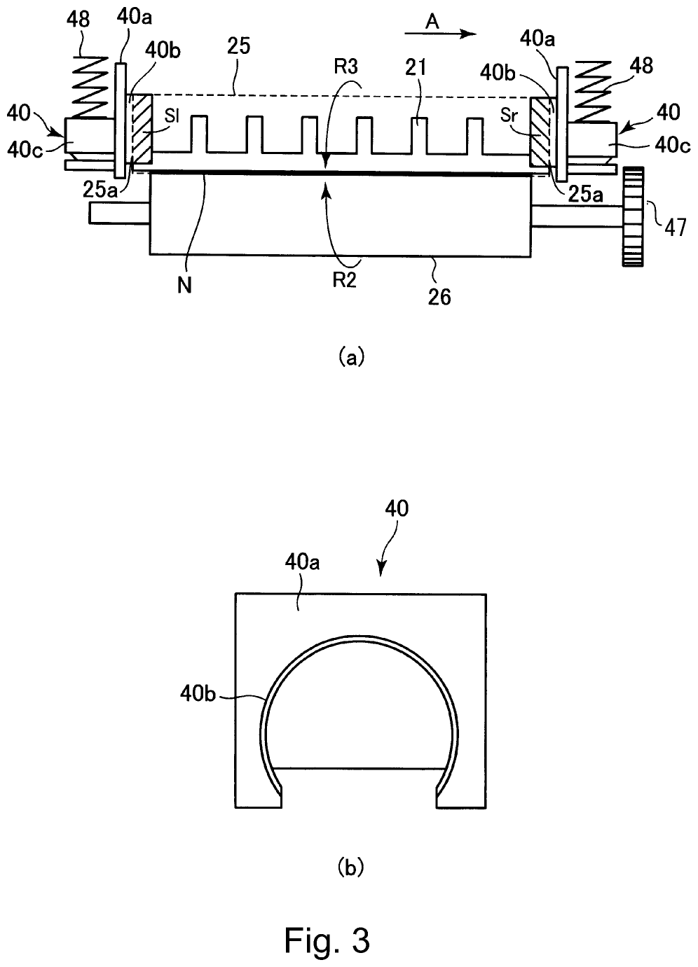

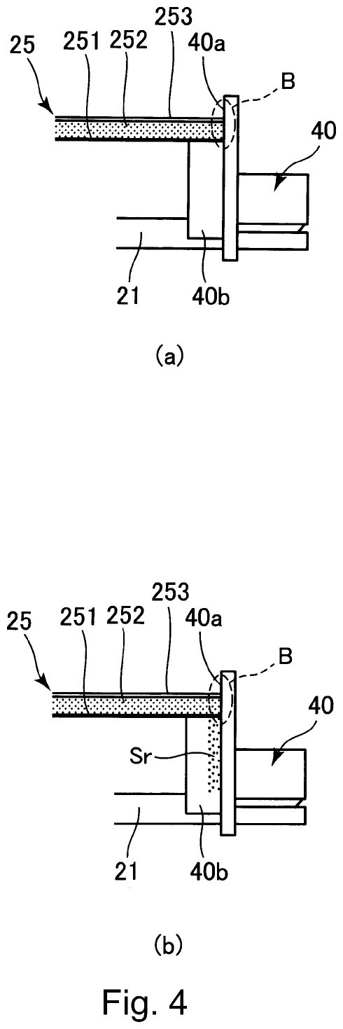

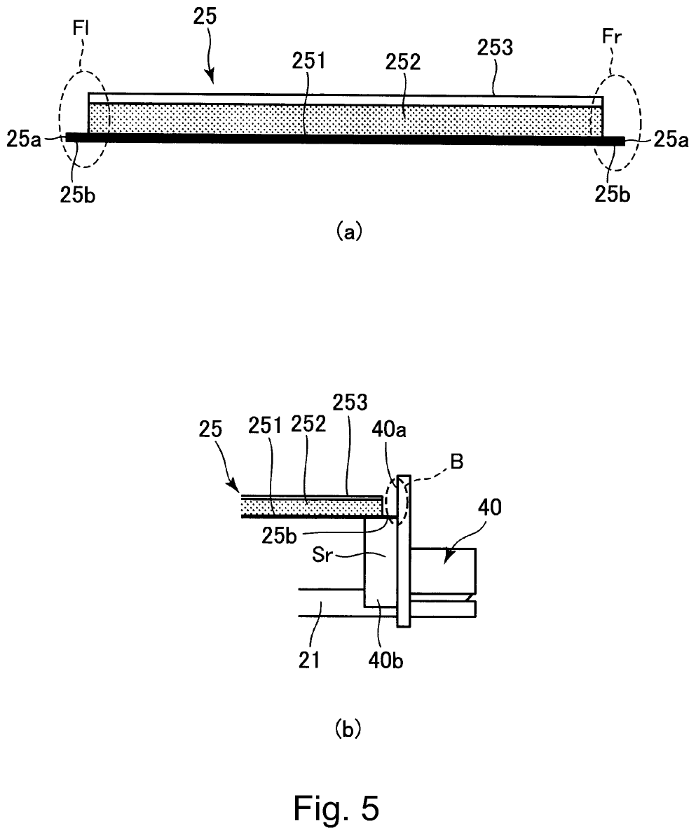

FIG. 2 is a schematic sectional view (cross section substantially perpendicular to a rotational axis direction of a pressing roller 26 described later) of the fixing device 130 of this embodiment. The image forming apparatus 100 of this embodiment includes the fixing device 130 of the film heating type as the heating apparatus (first heating apparatus, sheet heating apparatus).

The fixing device 13 is constituted by including a heater 20, a heater holder 21, a metal stay 22, a fixing film 25, the pressing roller 26, and the like. The heater 20 as a heating member is held by the heater holder 21 as a heating member. The heater holder 21 is supported by the metal stay 22. The heater 20, the heater holder 21, and the metal stay 22 extend in a direction substantially perpendicular to a feeding direction of the recording material P. The fixing film 25 is constituted by a cylindrical film (endless film). The fixing film 25 incorporates the heater 20, the heater holder 21, and the metal stay 22. Further, the fixing device 130 includes a flange 40 (FIG. 3) adjacent to an end portion of the fixing film 25 with respect to a widthwise direction substantially perpendicular to a circumferential direction (surface movement direction, recording material P feeding direction) of the fixing film 25 and as a restricting member for suppressing (restricting) movement (shift) of the fixing film 25 in the widthwise direction. In this embodiment, two flanges 40 are provided adjacent to opposite end portions of the fixing film 25 with respect to the widthwise direction. In this embodiment, each flange 40 not only supports the heater holder 21 and the metal stay 22 but also has a function as a supporting member for slidably supporting (guiding) the end portion of the fixing film 25 with respect to the widthwise direction.

The fixing device 130 forms a fixing nip N, between the fixing film 25 as a rotatable heating member and the pressing roller 26 as a rotatable pressing member, which is a nip where an outer surface of the fixing film 25 and a surface (outer peripheral surface) of the pressing roller 26 are in contact with each other. In this embodiment, on each of the opposite end portions of the fixing film 25 with respect to the widthwise direction, the flange 40 is urged by a pressing spring 48 (FIG. 3) which is an urging member as an urging means, so that the heater 20 is pressed toward the pressing roller 26 via the metal stay 22 and the heater holder 21. The fixing device 130 fixes the toner image T on the recording material P by utilizing heat of the heater 20 while nipping and feeding the recording material P in the fixing nip N. An energization controller 272 connected to a commercial AC power source controls electric power supplied to the heater 20 by a signal from a control circuit 271. The control circuit 271 and the energization controller 272 constitute a fixing driving portion 27.

### <Heater>

The heater 20 includes a heat-resistant heater substrate 201 formed of ceramic such as aluminum nitride or alumina. On a surface of the heater substrate 201, a resistor pattern 202 as an electroconductive heat generating resistor layer which generates heat by energization is formed by, for example, printing. Further, on a back surface (surface opposite from the fixing nip N) of the heater substrate 201, a thermistor 204 as a temperature detecting member for detecting a temperature of the heater 20 is provided. Further, a surface of the heater substrate 201 contacting the inner surface (inner peripheral surface) of the fixing film 25 is covered with an overcoating glass 205 for electrical insulation and anti-wearing property.

As a material of the heater holder 21, a heat-resistant resin material such as a liquid crystal polymer (LCP), phenolic resin, PPS (polyphenylene sulfide), or PEEK (polyether ether ketone) is used. The heater holder 21 not only acts as a holding member for holding the heater 20 but also acts as a guiding member for guiding rotation of the fixing film 25.

### <Pressing Roller>

The pressing roller 26 includes a core shaft portion (core metal) 261, an elastic layer 262 provided on an outer periphery of the core shaft portion 261, and a surface layer 263 provided on an outer periphery of the elastic layer 262. In this embodiment, an outer diameter of the pressing roller 26 is about 25 mm. As the core shaft portion 261, a solid or hollow cylindrical, or cylindrical member formed of a metal material such as aluminum (including aluminum alloy) or iron is used. In this embodiment, the core shaft member 261 is a solid cylindrical member mode of aluminum. Further, in this embodiment, the elastic layer (elastic member layer) 262 is formed with a heat-resistant silicone rubber which is an elastic member and as an electroconductive agent, for example, an electron-conductive agent such as carbon black is added, so that electroconductivity is imparted. Further, the surface layer 263 contacting an outer surface (outer peripheral surface) of the pressing roller 26 is constituted by a parting tube which is formed of a fluorine-containing resin material such as PFA, PTFE or FEP and which is 10 μm or more and 80 μm or less in thickness. Here, the PFA is an abbreviation of tetrafluoroethylene-perfluoroalkylvinyl ether copolymer, the PTFE is an abbreviation of polytetrafluoroethylene, and the FEP is an abbreviation of tetrafluoroethylene-hexafluoropropylene copolymer. The surface layer 263 may desirably impart electroconductivity from the viewpoint of suppressing charge-up of the pressing roller 26 with passing of the recording material P through the fixing nip N. In this embodiment, as a material of the surface layer 263 of the pressing roller 26, PFA to which the electroconductivity is imparted was used. As a method of imparting the electroconductivity, a method in which as the electroconductive agent, for example, the electron-conductive agent such as carbon black, an ion-conductive agent such as a metal complex, or the like is added has been known. In this embodiment, the surface layer 263 of the pressing roller 26 is constituted by adding the carbon black in a 30 μm-thick PFA tube, and an electric resistance value is suppressed to about 10⁵ Ω/cm².

### <Schematic Structure of Fixing Film>

The fixing film 26 has a cylindrical shape of 24 mm in diameter in this embodiment. The fixing film 25 has flexibility, and is loosely fitted externally around the heater holder 21. The fixing film 25 includes a plurality of layers including an elastic layer. In a circle in FIG. 2, a layer structure of the fixing film 25 in this embodiment is shown. In this embodiment, the fixing film 25 includes a base layer 251, an elastic layer 252, and a surface layer 253 in turn from an inside (heater 20 side) toward an outside (pressing roller 26 side).

As a material of the base layer 251, a low thermal-capacitance heat-resistant resin material such as polyimide, polyamideimide, PEEK or PES (polyether sulfone) is used. A thickness of the base layer 251 may desirably be set so as to not only satisfy a quick start property by making thermal capacity of the base layer 251 small but also satisfy mechanical strength of the base layer 251. From these viewpoints, the thickness of the base layer 251 may be, for example, 18 μm or more and 150 μm or less depending on a device structure in some instances. However, from the above-described viewpoints, the thickness of the base layer 251 may more preferably be 30 μm or more and 100 μm or less, further preferably be 50 μm or more and 80 μm or less. In this embodiment, the base layer 251 is a 70 μm-thick cylindrical polyimide layer. Further, in this embodiment, to the base layer 251, electroconductivity is imparted by adding, as the electroconductive agent, for example, the electron-conductive agent such as the carbon black or the ion-conductive agent such as the metal complex to the resin material as a base material.

As a material of the elastic layer 252, a material (elastic material) having elasticity, represented by a silicone rubber is used. In this embodiment, the silicone rubber was used as the elastic material of the elastic layer 252. Incidentally, as the material of the elastic layer 252, a fluorine-containing rubber or the like can also be used. The fixing film 25 is provided with the elastic layer 252, whereby heat can be uniformly imparted to the toner image T so as a to enclose the toner image T, and therefore, it becomes possible to obtain a good image with no unevenness. The elastic material of (for example, the silicone rubber) of the elastic layer 252 is low in thermal conductivity by itself. For that reason, to the elastic material of the elastic layer 252, a thermal-conductive filler is added, so that high thermal conductivity is imparted. As the thermal-conductive filler, ceramic powder, metal oxide powder, metal powder, or the like is used. As the thermal-conductive filler, from the viewpoint that good thermal conductivity is obtained, alumina, metal silicon, silicon carbide, zinc oxide, or the like is preferred. In a high-speed machine as in this embodiment, an addition amount of the thermal-conductive filler is appropriately adjusted, so that it is preferable that the thermal conductivity of 0.9 W/m·K or more is ensured for the elastic layer 252. In this embodiment, to the rubber material of the elastic layer 252, alumina and metal silicon are added as the thermal-conductive filler, the thermal conductivity of the elastic layer 252 was adjusted to 1.5 W/m·K. Further, the thickness of the elastic layer 252 may preferable be 30 μm or more and 500 μm or less from the viewpoints that not only the fixing property is improved but also desired thermal conductivity is easily obtained by use of the elastic material. From these viewpoints, the thickness of the elastic layer 252 may more preferably be 100 μm or more and 400 μm or less, further preferable be 200 μm or more and 300 μm or less. In this embodiment, the thickness of the elastic layer 252 was 270 μm. Incidentally, a content of the thermal-conductive filler in the elastic layer 252 may suitably be about 5 wt. % or more and about 50 wt. % or less.

Here, the thermal-conductive filler is constituted by a material higher in hardness than a principal material (base material, main component) of the base layer 251 of the fixing film 25. Incidentally, values of hardness of the base material (the resin material in this embodiment) of the base layer 251 of the fixing film 25 and the thermal-conductive filler (the inorganic material in this embodiment) can be compared with each other by Vickers hardness or the like of test pieces of the respective materials.

The surface layer 253 acts as the parting layer. The surface layer 253 is required to have a high parting property from the toner and a high anti-wearing property. As the material of the surface layer 253, the fluorine-containing resin material such as PFA, PTFE, or FEP is used. The surface layer 253 is formed by a coating layer obtained by baking a resin dispersion or by a tube layer formed of a resin material. Further, to the fluorine-containing resin material of the surface layer 253, as the electroconductive agent, for example, an additive which is the electron-conductive agent such as the carbon black, the ion-conductive agent such as the metal complex, or the like is added, the electroconductivity may also be imparted. In this embodiment, the surface layer 253 is constituted by a tube layer formed with the PFA as the fluorine-containing resin material, and the electroconductive agent is added. Further, the thickness of the surface layer 253 may preferably be 1 μm or more and 50 μm or less from the viewpoints that not only the parting property and the anti-wearing property are improved as described above but also desired thermal conductivity is easily obtained, and the like. From these viewpoints, the thickness of the surface layer 253 may more preferably be 5 μm or more and 40 μm or less, further preferably be 10 μm or more and 30 μm or less. In this embodiment, the thickness of the surface layer 253 was 25 μm.

Incidentally, the fixing film 25 may also employ a constitution in which the surface layer 253 is not provided, for example, by using a fluorine-containing rubber as a material of the elastic layer 252 or by containing fluorine-containing resin particles in the rubber material of the elastic layer 252.

### <Flange>

Part (a) of FIG. 3 is a sectional side view of the fixing device 130 of this embodiment as viewed from an upstream side of the feeding direction of the recording material P. In part (a) of FIG. 3, the fixing film 25 is shown by a broken line, and an inside thereof is seen through. Further, part (b) of FIG. 4 is a front view (a view seen from a center side along the widthwise direction of the fixing film 25) of the flange 40. Incidentally, in this embodiment, the recording material P is fed on a center(-line) basis. Further, in this embodiment, in the fixing device 130, a constitution of the flange 40 and a constitution of the end portion, with respect to the widthwise direction, of the fixing film 25 described later are similar (substantially symmetrical with respect to an approximate center with respect to the widthwise direction) on opposite end portion sides with respect to a direction substantially perpendicular to the feeding direction of the recording material P. In the following, an end portion on a right(-hand) side (a rear side of the image forming apparatus 100 corresponding to a rear side of the drawing sheet of FIG. 1) in part (a) of FIG. 1 will be principally described as an example.

In this embodiment, the flange 40 includes a restricting surface 40a which is a region where the flange 40 is contactable to an end surface 25a of the end portion of the fixing film 25 with respect to the widthwise direction. Further, in this embodiment, the flange 40 includes a guide (guiding) surface 40b which is a region where the flange 40 is contactable to an inner surface of the end portion of the fixing film 25 with respect to the widthwise direction. In this embodiment, the guide surface 40b is formed by a projected outer peripheral surface having a substantially cylindrical shape (a partially cylindrical shape such that a lower part in the figure is open) projected from an end portion side toward a central side of the fixing film 25 with respect to the widthwise direction. Further, in this embodiment, the restricting surface 40a is formed by a substantially flat wall surface which is formed so as to extend to an outside of the guide surface 40b in a radial direction of the guide surface 40b and which extends along a flat plane substantially perpendicular to the widthwise direction of the fixing film 25. Further, the flange 40 includes a flange end portion 40c projected along the widthwise direction of the fixing film 25 toward an opposite side (outside) to a side where the restricting surface 40a and the guide surface 40b are provided. Incidentally, inside the substantially cylindrical-shaped projection constituting the guide surface 40b of the flange 40 (or further inside the flange end portion 40c), a supporting portion (not shown) for supporting the metal stay 22 or the like is provided. With respect to the widthwise direction of the fixing film 25, a width (length between the end surfaces 25a) of the fixing film 25 is set so as to be shorter than a distance between the restricting sides 40a of the flange 40 on opposite sides. The flange 40 restricts movement of the fixing film 25 in the widthwise direction. On the other hand, the flange 40 suppresses deformation of the fixing film 25 toward an inner surface direction and inclination of the fixing film 25 relative to the recording material P by the guide surfaces 40b. Particularly, in the case where polyimide having high flexibility is used for the base layer 251 of the fixing film 25, the deformation of the fixing film 25 toward the inner surface direction becomes conspicuous, and therefore, it is desired that a shape of the fixing film 25 of the fixing film 25 is appropriately maintained by the guide surfaces 40b. The guide surfaces 40b are formed so that the inner surfaces of the fixing film 25 at the opposite end portions with respect to the widthwise direction contact the guide surfaces 40b even in a state in which the fixing film 25 contacts the restricting surface 40a on either one of the opposite end portion sides.

Further, the pressing roller 26 receives a rotational driving force from a driving gear 47 on one end portion side thereof with respect to a rotational axis direction thereof, and is rotated in an arrow R2 direction in part (a) of FIG. 3. To the driving gear 47, the rotational driving force is transmitted from a fixing driving motor (not shown) as a driving source constituting a driving means. The fixing film 25 receives the rotational driving force from the pressing roller 26 in the fixing nip N, and is rotated in an arrow R3 direction in part (a) of FIG. 3. That is, in this embodiment, the fixing film 25 is rotated with rotation of the pressing roller 26.

The fixing film 25 shifts toward either one of the end portion sides with respect to the widthwise direction thereof during rotation thereof in some cases. In order to restrict the shift thereof, the flanges 40 are provided adjacent to the opposite end portions of the fixing film 25 with respect to the widthwise direction. For example, in the case where the shift of the fixing film 25 in an arrow A direction (rightward direction) in part (a) of FIG. 3 occurs, a right-side end surface 25a of the fixing film 25 in part (a) of FIG. 3 abuts against the restricting surface 40a of a right-surface flange 40 in part (a) of FIG. 3, so that the shift of the fixing film 25 is restricted.

On the other hand, the flange 40 includes the guide surface 40b contacting the inner surface of the fixing film 25, so that the inner surface of the fixing film 25 at the end portion with respect to the widthwise direction is guided by this guide surface 40b. Contact regions Sl and Sr each between the guide surface 40b of the flange 40 and the inner surface of the fixing film 25 are indicated by hatched portions in part (a) of FIG. 3. Incidentally, part (a) of FIG. 3 shows a state in which the shift of the fixing film 25 does not occur and in which the fixing film 25 is in a nominal position (position where a center of the fixing film 25 with respect to the widthwise direction coincides with an approximate center of a direction substantially perpendicular to the feeding direction of the recording material P). When the inner surface of the fixing film 25 contacts and slide on the guide surface 40b of the flange 40, heat necessary to fix the toner is taken by the flange 40. For that reason, the guide surface 40b of the flange 40 is provided so as to contact the fixing film 25 on an outside (on a left or right side relative to a feeding region of the recording material P) of the feeding region of the recording material P with respect to the direction substantially perpendicular to the feeding direction of the recording material P.

That is, with respect to the direction substantially perpendicular to the feeding direction of the recording material P, each of the above-described contact regions S1 and Sr is positioned outside the feeding region of the recording material P. Incidentally, the feeding region of the recording material P is a region, of the recording material P on which the fixing device 130 is capable of fixing the toner image, where a recording material having a maximum size in length with respect to the direction substantially perpendicular to the recording material feeding direction passes. In this embodiment, the width (a projected length of the above-described substantially cylindrical projection) of the guide surface 40b of the flange 40 with respect to the widthwise direction of the fixing film 25 was set at 4 mm.

A material of the flange 40 may desirably have hardness equivalent to the base layer 251 of the fixing film 25 which is slidable mating member. The reason therefor is that abrasion of the inner surface of the base layer 251 of the fixing film 25 at the end portion with respect to the widthwise direction occurs when the hardness of the flange 40 is excessively harder than the hardness of the base layer 251 and abrasion of the flange 40 occurs when the hardness of the flange 40 is excessively softer than the hardness of the base layer 251. In this embodiment, as the material of the flange 40, the liquid crystal polymer (LCP) was used. Incidentally, as the material of the flange 40, it is possible to use resin materials such as PET (polyethylene terephthalate), PC (polycarbonate), POM (polyacetal), ABS, polyimide, polyamide, polyamideimide, PEEK, PES, PPS, and the liquid crystal polymer (LCP), and mixed resin materials of these.

Further, the flange 40 performs a function such that the flange 40 receives a pressing force by a pressing spring 48 at the flange end portion 40c and imparts the pressing force to the heater holder 21 via the metal stay 21 (FIG. 2). By this pressing force, the fixing nip N is formed between the fixing film 25 and the pressing roller 26, so that heat and pressure are applied to the unfixed toner T on the recording material P and thus the toner T is fixed on the recording material P.

### 3. Problem

Here, a conventional problem will be further described. As described above, in the case where the thermal-conductive filler contained in the elastic layer 251 is increased for realizing high thermal conductivity of the fixing film 25 or in the like case, abrasion of the elastic layer 251 of the fixing film 25 is liable to occur in some instances. Particularly, as in this embodiment, in the case of a constitution in which the flange 40 includes the restricting surface 40a and the guide surface 40b, abrasion of the inner surface of the fixing film 25 with respect to the widthwise direction (hereinafter, referred simply to as “inner surface abrasion”) is liable to occur in some instances. As a result, buckling of the end portion of the fixing film 25 with respect to the widthwise direction is liable to occur, so that there is a possibility that the occurrence of the buckling prevents lifetime elongation of the fixing film 25.

With reference to FIG. 4, a mechanism for the occurrence of the inner surface abrasion of the fixing film 25 including the elastic layer 252 containing the thermal-conductive filler will be described. Parts (a) and (b) of FIG. 4 are schematic sectional side views of a neighborhood of the right-side flange 40 in part (a) of FIG. 3 as viewed from an upstream side of the feeding direction of the recording material P in a fixing device 130 of a comparison example in which a fixing film 25 does not have a constitution in accordance with the present invention. In these figures, a cross section of the fixing film 25 along the widthwise direction and a side surface of the flange 40 are shown. Incidentally parts (a) and (b) of FIG. 4 each shows a state in which the fixing film 25 causes a shift in a rightward direction in part (a) of FIG. 3 and contacts the restricting surface 40a of the right-side flange 40 in part (a) of FIG. 3. Further, also, as regards the comparison example, elements corresponding to those of this embodiment will be described by adding the same reference numerals or symbols.

The fixing film 25 receives a shifting force in the widthwise direction due to oblique movement of the recording material, deviation of alignment thereof with the pressing roller 26 and the like, so that the fixing film 25 is slid and rotated while being pressed by the restricting surface 40a of the flange 40 in some instances. As shown in part (a) of FIG. 4, the fixing film 25 and the restricting surface 40a of the flange 40 slide with each other in a sliding region B. The fixing film 25 is constituted by the base layer 251, the elastic layer 252, and the surface layer 253, and the base layer 251 and the elastic layer 252 are abraded (worn) by sliding of the base layer 251 and the elastic layer 252 with the restricting surface 40a. In the elastic layer 252, the thermal-conductive filler is contained. For that reason, the elastic layer 252 is abraded by the restricting surface 40a of the flange 40, so that the thermal-conductive filler contained in the elastic layer 252 is abraded from the end surface of the elastic layer 252. A part of the abraded thermal-conductive filler passes (slides) through the sliding region B between the end portion of the fixing film 25 with respect to the widthwise direction and the restricting surface 40a of the flange 40. Then, the thermal-conductive filler goes around to the contact region Sr between the inner surface of the base layer 251 of the fixing film 25 and the restricting surface 40a of the flange 40 as shown in part (b) of FIG. 4. By this, the thermal-conductive filler exists in this contact region Sr. The thermal-conductive filler is constituted in this embodiment by the material higher in hardness than a principal material (main component, base material) of the base layer 251 of the fixing film 25 which is polyimide being the resin material. For that reason, the fixing film 25 is slid and rotated on the guide surface 40b of the flange 40, so that in the above-described contact region Sr, the abrasion of the inner surface of the end portion of the base layer 25 with respect to the widthwise direction is promoted by the thermal-conductive filler interposed between the inner surface of the base layer 251 and the guide surface 40b.

When the inner surface abrasion of the base layer 251 of the fixing film 25 occurs, the thickness of the base layer 251 lowers with an increase of a use amount of the fixing film 25, and strength of the fixing film 25 lowers, so that there is a possibility that buckling of the end portion of the fixing film 25 occurs by a lower shifting force. For that reason, there is a possibility that the occurrence of the buckling prevents lifetime elongation the fixing film 25. On the other hand, in order to satisfy the lifetime elongation by suppressing this buckling, it would be considered that the thickness of the base layer 251 of the fixing film 25 is increased. However, when the base layer 251 is made excessively thick, there is a possibility that the thermal conductivity lowers and thus a fixing performance lowers, and there is also a possibility that a cost increases. Thus, in the constitution of the comparison example (conventional constitution), there is a possibility that it becomes difficult to compatibly realize the speed-up and the lifetime elongation.

### 4. Structure of End Portion of Fixing Film

Next, a structure of the fixing film 25 in this embodiment will be further described. Part (a) of FIG. 5 is a sectional view of the fixing film 25 along the widthwise direction in this embodiment.

In this embodiment, the fixing film 25 is constituted so that the elastic layer 252 does not contact the restricting surface 40a in the case where the base layer 251 contacts the restricting surface 40a of the flange 40 at the end portion of the fixing film 25 with respect to the widthwise direction. In this embodiment, the fixing film 25 has such a constitution at the opposite end portions with respect to the widthwise direction. Specifically, in this embodiment, as shown in part (a) of FIG. 5, the fixing film 25 includes a portion 25b constituted only by the base layer 251 without including the elastic layer 252 and the surface layer 253 at each of opposite end portions Fl and Fr with respect to the widthwise direction (hereinafter, this portion is also referred to as a “base layer projected portion”). Incidentally, in this embodiment, the surface layer 253 is provided at the surface of the elastic layer 252, and therefore, the base layer projected portion 25b does not include the elastic layer 252 and the surface layer 253. However, in the case of a constitution in which the surface layer 253 is not provided, the base layer projected portion 25b may only be required that the base layer projected portion 25b does not include the elastic layer 252. In other words, in this embodiment, the fixing film 25 includes the base layer projected portion (base layer exposed portion) 25b where the elastic layer 252 is not provided and the base layer 251 is exposed at each of the opposite end portions Fl and Fr with respect to the widthwise direction.

Incidentally, even in a state in which the fixing film 25 is positioned at any phase with respect to a circumferential direction thereof, in the case where the base layer 251 contacts the restricting surface 40a of the flange 40, it is desired that the elastic layer 252 is constituted so as not to contact the restricting surface 40a. For that reason, in this embodiment, the base layer projected portion 25b is provided continuously over an entire region of the fixing film 25 with respect to the circumferential direction. In this embodiment, thus, the base layer projected portion 25b is provided continuously over the entire region of the fixing film 25 with respect to the circumferential direction, and the end surface 25a of the end portion of the fixing film 25 with respect to the widthwise direction is constituted by an end surface of the base layer projected portion 25a. However, when an effect of the present invention is sufficiently achieved, in at least one end portion of the fixing film 25 with respect to the widthwise direction, a portion where the base layer projected portion 25a is not provided may also be formed at a part of the fixing film 25 with respect to the circumferential direction. In the portion where the base layer projected portion 25b is not provided, the end surface of the end portion of the fixing film 25 with respect to the widthwise direction is constituted by the base layer 251 and the elastic layer 252 (and further the surface layer 253 in this embodiment). Although the present invention is not limited to this, the base layer projected portion 25b is provided is a length of 70% or more, preferably 80% or more, further preferably 90% or more, and typically over the entire region (length) of a peripheral length of the fixing film 25.

By using the fixing film 25 of this embodiment, it is possible to suppress the above-described inner surface abrasion of the fixing film 25. With reference to part (b) of increase FIG. 5, the reason therefor will be described. Part (b) of FIG. 5 is a schematic sectional side view of a neighborhood of the right-side flange 40 of the fixing device 130 in this embodiment in part (a) of FIG. 3 as viewed from the upstream side of the feeding direction of the recording material P. In the figure, a cross section of the fixing film 25 along the widthwise direction and a side surface of the flange 40 are shown. Incidentally, part (b) of FIG. 5 shows a state in which a shift of the fixing film 25 in the rightward direction in part (a) of FIG. 3 occurs and the fixing film 25 contacts the restricting surface 40a of the light-side flange 40 in part (a) of FIG. 3.

As shown in part (b) of FIG. 5, in this embodiment, in the sliding region B between the end portion of the fixing film 25 with respect to the widthwise direction and the restricting surface 40a of the flange 40, the restricting surface 40a of the flange 40 contacts only the base layer 251 of the fixing film 25 and does not contact the elastic layer 252. By this, abrasion of the thermal-conductive filler contained in the elastic layer 252 is prevented or is sufficiently suppressed. As a result, in the contact region Sr between the inner surface of the base layer 251 of the fixing film 25 and the guide surface 40b of the flange 40, the thermal-conductive filler is not interposed, so that the inner surface of the base layer 251 of the fixing film 25 and the guide surface 40b of the flange 40 slide with each other. Accordingly, the abrasion of the inner surface of the end portion of the fixing film 25 with respect to the widthwise direction can be suppressed. Thus, according to this embodiment, the inner surface abrasion of the fixing film 25 can be suppressed.

### 5. Setting of Base Layer Projected Portion

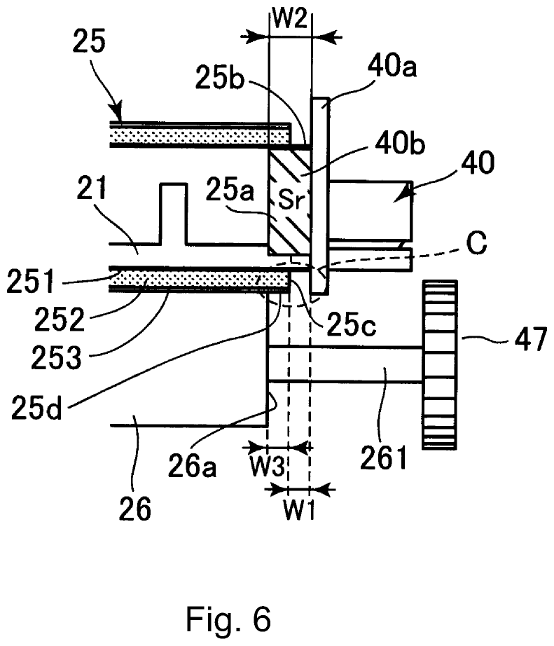

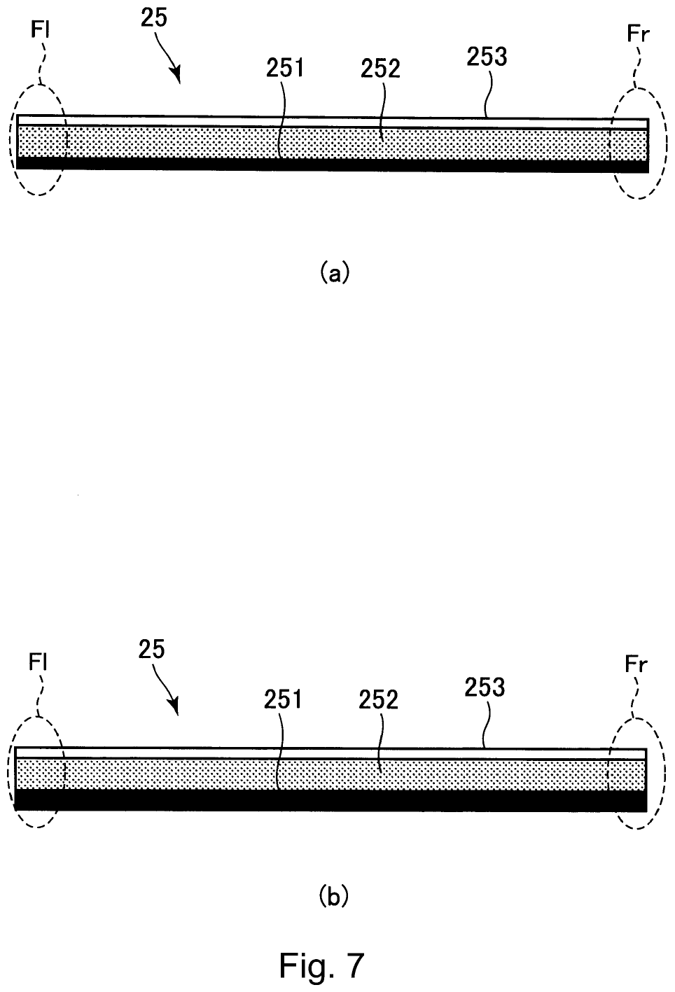

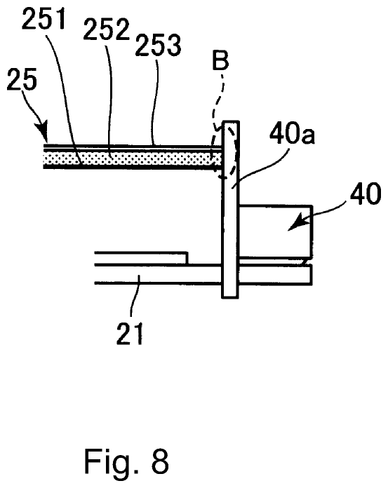

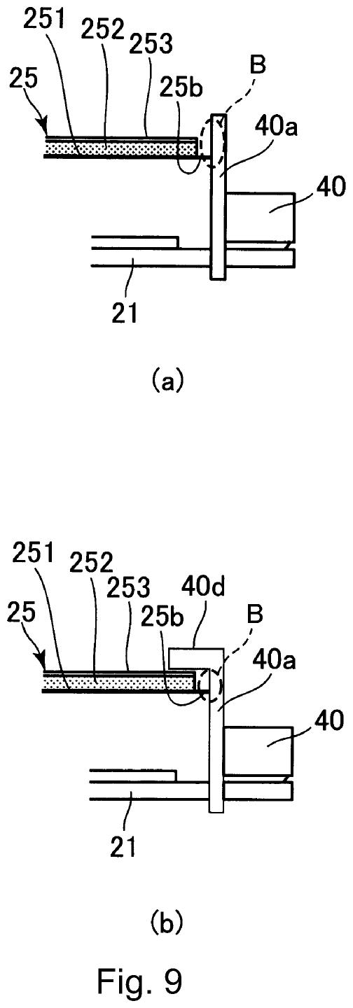

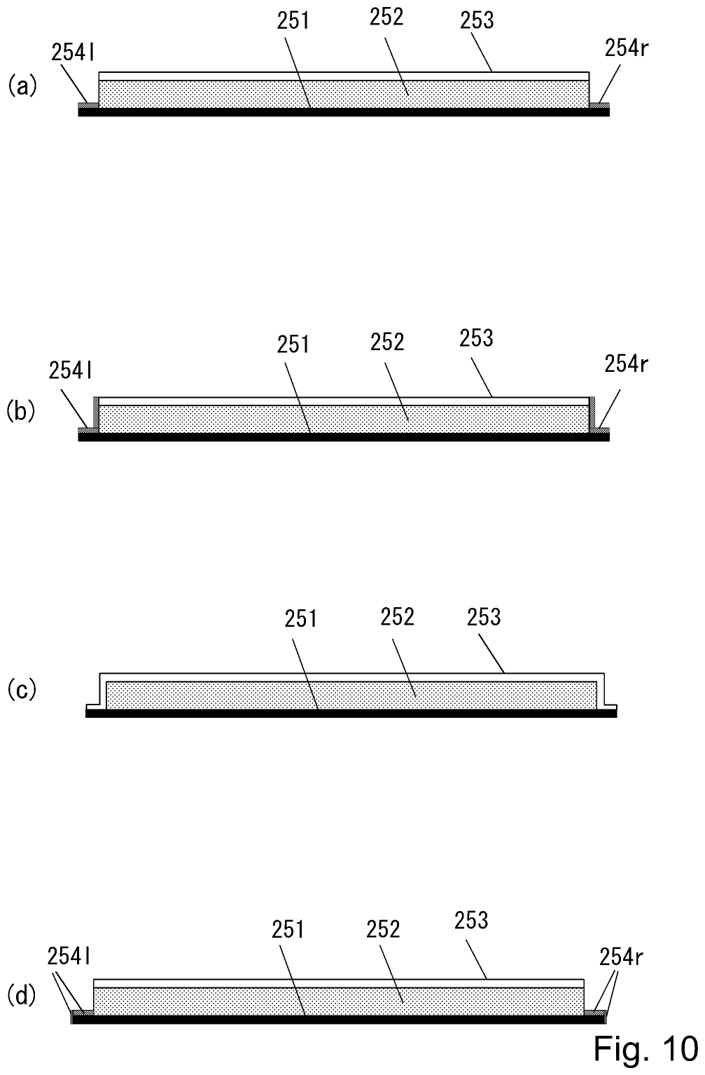

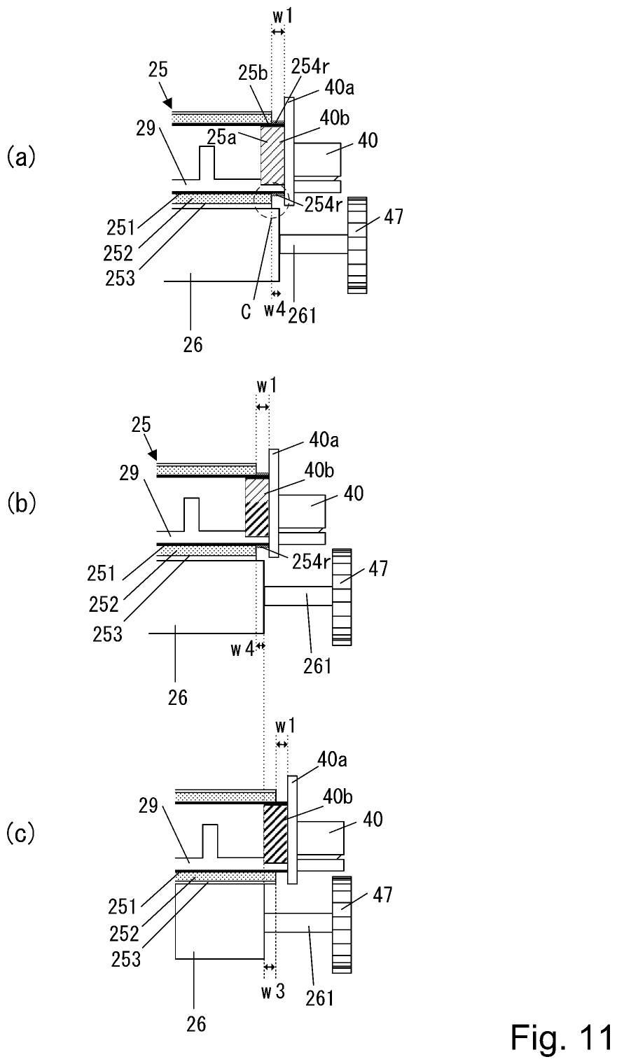

Next, setting of the base layer projected portion 25b will be further described. FIG. 8, the reason therefor will be described. Part (b) of FIG. 5 is a schematic sectional side view of a neighborhood of the right-side flange 40 of the fixing device 130 in this embodiment in part (a) of FIG. 3 as viewed from the upstream side of the feeding direction of the recording material P. In the figure, a cross section of the fixing film 25 along the widthwise direction and a side surface of the flange 40 and the pressing roller 26 are shown. Incidentally, FIG. 6 shows a state in which a shift of the fixing film 25 in the rightward direction in part (a) of FIG. 3 occurs and the fixing film 25 contacts the restricting surface 40a of the light-side flange 40 in part (a) of FIG. 3.

### <Width of Base Layer Projected Portion>

A width of the base layer projected portion 25b of the fixing film 25 with respect to the widthwise direction (hereinafter, this width is simply referred to as a “projected width”) is indicated as W1 in FIG. 6. Incidentally, the projected width W1 is represented by a value (initial value) in an initial stage (during a brand-new state) of use of the fixing film 25. The projected width W1 is desired to be set so that with respect to the widthwise direction of the fixing film 25, the elastic layer 252 does not extend to an outside of the base layer 251 even when, for example, expansion of the elastic layer due to heating or abrasion of the base layer 251 from an end surface with an increase in use amount, and the like are taken into consideration. From such a viewpoint, the projected width W1 may preferably be set at 0.1 mm or more. Further, from the above-described viewpoint, the projected width W1 may more preferably be set at 0.3 mm or more, and further preferably be set at 0.5 mm or more. Further, the projected width W1 can be arbitrarily be set in consideration of a lifetime of the fixing film 25, or the like. For example, the projected width W1 may preferably be set at a larger value with the fixing film 25 used in the fixing device 130 longer in lifetime. However, from the viewpoints of mechanical strength, travel stability, and the like, the projected width W1 may preferably be 10 mm or less, more preferably be 4 mm or less, and typically be 2 mm or less. Further, with respect to the widthwise direction of the fixing film 25, a width of the portion including the base layer 251 and the elastic layer 252 (and further the surface layer 253 in this embodiment) of the fixing film 25 is larger than a width of the feeding region of the recording material P, and the feeding region of the recording material P falls within an inside of this portion. In this embodiment, at each of the opposite end portions of the fixing film 25 with respect to the widthwise direction, in the entire region of the fixing film 25 with respect to the circumferential direction, the projected width W1 of the base layer projected portion 25b was set at 1 mm.

Incidentally, in this embodiment, the projected width W1 is 2 mm, and a width W2 of the guide surface 40b of the flange 40 with respect to the widthwise direction of the fixing film 25 is 4 mm. That is, in this embodiment, at least in a state in which the fixing film 25 contacts the restricting surface 40b of one of the flanges 40, the guide surface 40b of the flange 40 and a region of the fixing film 25 in which the elastic layer 252 exists overlap with each other with respect to the widthwise direction of the fixing film 25. Thus, the region of the fixing film 25 in which the elastic layer 252 exists, and the guide surface 40b of the flange 40 are caused to overlap with each other, so that traveling stability of the fixing film 25 can be maintained at a high level. That is, the projected width W1 may preferably be set so as to be smaller (narrower) than the width W2 of the guide surface 40b of the flange 40 with respect to the widthwise direction of the fixing film 25.

Here, as described above, with respect to the widthwise direction of the fixing film 25, the width (length between the opposite end surfaces 25a) of the fixing film 25 is set so as to shorter than a distance between the restricting surfaces 40a of the flanges on opposite end sides. This is because even when the thermal expansion or the like is taken into consideration, the width of the fixing film 25 is prevented from becoming larger than the distance between the restricting surfaces 40a. For example, the distance between the restricting surfaces 40a is made larger than the width of the fixing film 25 by about 1 mm or more and about 3 mm or less. In this case, in a state in which the shift of the fixing film 25 does not occur and the fixing film 25 is in a nominal position, a clearance between the end surface of the fixing film 25 and the corresponding restricting surface 40a of the flange 40 is about 0.5 mm or more and about 1.5 mm or less. From the viewpoint of the above-described traveling stability, the projected width W1 may preferably be smaller than a value obtained by subtracting the clearance from the width W2 of the above-described guide surface 40b. Further, the projected width W1 may further preferably be smaller than a value obtained by subtracting a difference (which is about twice the above-described clearance) between the width of the fixing film 25 and the distance between the restricting surfaces 40a from the width W2 of the guide surface 40b.

### <Position of End Portion of Pressing Roller>

Further, in this embodiment, a positional relationship between the end portion of the fixing film 25 and the end portion of the pressing roller 26 is set in the following manner. As described above, in this embodiment, the pressing roller 26 is constituted by the electroconductive core shaft portion 261, the elastic layer 262, and the surface layer 263 formed of PFA to which the electroconductivity is imparted. Further, as shown in FIG. 2, the core shaft portion 261 of the pressing roller 26 is electrically grounded via a resistor 31 and a diode 32. In this embodiment, the resistor 31 is 1 MΩ, and the diode 32 is provided so that an anode side thereof is connected to the core shaft portion 261 of the pressing roller 26. The purpose of using such an electrical circuit is that a surface potential of the pressing roller 26 is maintained at a potential of an opposite polarity (positive (+) polarity in this embodiment) to the charge polarity of the toner and that a potential of the transfer roller 5 is appropriately maintained as described later. The transfer roller 5 transfers the toner image from the photosensitive drum 1 onto the recording material P under application of a voltage thereto of the opposite polarity (the positive polarity in this embodiment) to the toner charge polarity. Here, when the image is formed on the recording material P ranging both the fixing nip N and the transfer nip Nt, an electric circuit connecting the transfer roller 5, the recording material P, and the pressing roller 26 is formed. At this time, by the presence of the above-described diode 32, the positive voltage applied to the transfer roller 5 prevents a current from flowing through the ground via the recording material P and the pressing roller 5 (this is also called leakage of a transfer current), and thus prevents a lowering in surface potential of the transfer roller 5.

On the other hand, as shown in FIG. 2, the fixing film 25 is electrically grounded via the metal stay 22 and the resistor 30 of 1 MΩ by bringing an electroconductive 291 into contact therewith from an inner surface of the base layer 251. Here, the electric circuit of the fixing film 25 is not provided with a diode. The reason why the diode is not provided is because the surface layer 253 of the fixing film 25 is electrically insulative, and therefore, there is no concern for leakage of a transfer current due to a transfer voltage via the recording material P and the fixing film 25.

When the constitution of this embodiment is used, it is desired that a positional relationship between the base layer projected portion 25b of the fixing film 25 and the end portion of the pressing roller 26. The reason therefor is because in the case where the base layer projected portion 25b of the fixing film 25 and the surface layer 263 of the pressing roller 26 are in contact with each other, there is a possibility that an image defect due to the leakage occurs. That is, the transfer current leaks from the base layer projected portion 25b of the fixing film 25 to the ground via the recording material P and the surface layer 263 of the pressing roller 26, and therefore, there is a possibility that the transfer potential of the surface of the transfer roller 5 cannot be properly maintained and the image defect occurs.

In order to prevent the image defect, a constitution in which contact between the surface layer 263 of the pressing roller 26 and the base layer 251 of the base layer projected portion 25b of the fixing film 25 is prevented is desired. In order to satisfy this constitution, in the opposite end portions of the fixing film 25 with respect to the widthwise direction in this embodiment, a positional relationship between the end portion of the fixing film 25 and the end portion of the pressing roller 26 is set in the following manner.

Here, as shown in FIG. 6, a region in which the surface layer 263 of the pressing roller 26 and the base layer 251 of the base layer projected portion 25b of the fixing film 25 as adjacent to each other is referred to as an adjacent region C. At this time, in the adjacent region C, the end portion (end surface) 25c of the elastic layer 252 and the surface layer 253 of the fixing film 25 is positioned outside the end portion (end surface) 26a of the elastic layer 262 of the pressing roller 26. That is, a constitution in which the elastic layer 252 and the surface layer 253 of the fixing film 25 includes an extended portion 25d extending outward from the end portion 26a of the elastic layer 262 of the pressing roller 26 by a width W3 with respect to the widthwise direction of the fixing film 25 is employed. By this, a creepage distance between the elastic layer 262 of the pressing roller 26 and the base layer 251 of the base layer projected portion 25b of the fixing film 25 can be sufficiently ensured, so that the above-described potential difference can be appropriately maintained. For that reason, it is possible to suppress an occurrence of the image defect as described above. The width W3 of the extended portion 25d can be appropriately set so that electric discharge as described above can be sufficiently suppressed depending on a potential difference between a potential applied to the core shaft portion 261 of the pressing roller 26 and a potential of the base layer 251 of the fixing film 25. In this embodiment, the width W3 of the extended portion 25d was set at 2 mm over an entire region of each of the fixing film 25 and the pressing roller 26 with respect to the widthwise direction.

As described above, according to this embodiment, it is possible to suppress the inner surface abrasion of the fixing film 25, so that the speed-up and the lifetime elongation can be compatibly realized.

Incidentally, in this embodiment, the above-described width W3 was set at 2 mm, but the present invention is not limited thereto. The width W3 should be set so that the base layer projected portion 25b of the fixing film 25 and the surface layer 263 of the pressing roller 26 does not contact each other through a lifetime period in consideration of mechanical accuracy of respective members and shortening of the fixing film 25 with respect to the widthwise direction with durability.

### 6. Confirmation of Effect

In order to confirm an effect of this embodiment, a comparison test between the constitution of this embodiment and constitutions of comparison examples was conducted. In the constitution of this embodiment, the fixing film 25 according to the present invention is used. In comparison examples 1 and 2, fixing films 25 shown in parts (a) and (b) of FIG. 7 are used, respectively. Constitutions of image forming apparatus 100 in the comparison examples 1 and 2 are substantially the same as the constitution of this embodiment except for the above-described point. Incidentally, also as regards the comparison examples 1 and 2, elements corresponding to the elements of this embodiment will be described by adding the same reference numerals or symbols.

Part (a) of FIG. 7 is a schematic sectional view of the fixing film 25 used in the constitution of the comparison example 1 and extending along the widthwise direction, and part (b) of FIG. 7 is a schematic sectional view of the fixing film 25 used in the constitution of the comparison example 2 and extending along the widthwise direction. Each of the fixing films 25 used in the comparison examples 1 and 2 is not provided with the elastic layer 252 at each of the opposite end portions Fl and Fr with respect to the widthwise direction and is not provided with the base layer projected portion (base layer exposed portion) where the base layer 251 is exposed. The fixing films 25 in the comparison examples 1 and 2 are different from each other in thickness. In the fixing film 25 of the comparison example 1, the thickness thereof was set at 70 μm by attaching importance to the fixing property (thermal conductivity). On the other hand, in the fixing film 25 of the comparison example 2, the thickness thereof was set at 110 μm by attaching importance to the durability.

In this embodiment and the comparison examples 1 and 2, the test was conducted in the following condition. A pressing force between the fixing film 25 and the pressing roller 26 was set at 186.2 N (19 kg.). A width (nip width) Wn of the fixing nip N with respect to the feeding direction of the fixing nip N was set at 9 mm. A test environment was 23° C. in temperature and 50% RH in relative humidity, such as a recording material P for evaluation, “CS-068” (A4-size, 68 g/m², available from Canon Marketing Japan Inc.) which is a recording sheet was used.

In the above-described condition, in this embodiment and the comparison examples 1 and 2, a sheet passing durability test in which printing of 200,000 sheets was conducted without printing the images, and evaluation of durability was performed. Further, the images were printed for each of 50,000 sheets, and evaluation of the fixing property was performed.

In a table 1, an evaluation result of the durability and the fixing is property is shown. An evaluation standard is as follows. As regards a level of the durability, the case where there is no problem on the durability of the fixing film 25 and the durability was good was represented by “◯ (Good)”, and the case where the problem on the durability of the fixing film 25 which is capable of becoming a practical problem occurred was represented by “× (Poor)”. As regards the fixing property, the case where there is no problem on the fixing property and the fixing property is good was represented by “◯(Good)”, and the case where the problem on the fixing property, which is capable of becoming a practical problem occurred was represented by “×(Poor)”.

TABLE 1

| | NOSP*¹ (×10³ sheets) | | | | |
|---|---|---|---|---|---|
| | 50 | 100 | 150 | 175 | 200 |
| | FP/D*² | FPD*² | FP/D*² | FP/D*² | FP/D*² |
| EMB. 1 | ∘/∘ | ∘/∘ | ∘/∘ | ∘/∘ | ∘/∘ |
| COMP. EX. 1 | ∘/∘ | ∘/x | ←STOP | | |
| COMP. EX. 2 | x/∘ | x/∘ | x/∘ | x/∘ | x/∘ |

*¹“NOSP” is the number of sheets passed.
*²“FP/D” is the fixing property/durability.

In the comparison example 1, at the time when printing of 100 K (100×10³) sheets was performed, buckling occurred at the end portion of the fixing film 25 with respect to the widthwise direction. As a result, traveling of the fixing film 25 become instable and the image defect occurred, and therefore, the sheet passing durability test was stopped. It turned out that the reason why the buckling at the end portion of the fixing film 25 occurred was the inner surface abrasion of the fixing film 25. That is, in the comparison example 1, the thickness of the base layer 251 at the end portion of the fixing film 25 with respect to the widthwise direction at the time when the printing of 100 K sheets was performed became thin to about 40 μm from 70 μm in an initial stage. For this reason, it would be considered that when the fixing film 25 contacts the restricting surface 40a of the flange 40, the fixing film 25 cannot withstand the shifting force applied thereto in the widthwise direction, and thus the buckling of the fixing film 25 at the end portion with respect to the widthwise direction occurred.

Further, in the comparison example 2, even when printing of 200 K (×10³) sheets was performed, the buckling did not occur at the end portion of the fixing film 25 with respect to the widthwise direction. It turned out that the reason therefor was that the thickness of the base layer 251 in the initial stage was excessively thick. That is, in the comparison example 2, the thickness of 50 μm remained in the base layer 251 at the end portion of the fixing film 25 with respect to the widthwise direction even when the printing of 200 K sheets was performed. For this reason, it would be considered that when the fixing film 25 contacts the restricting surface 40a of the flange 40, the fixing film 25 withstands the shifting force applied thereto in the widthwise direction, and thus the buckling of the fixing film 25 at the end portion with respect to the widthwise direction did not occur. However, in the comparison example 2, from the initial stage, improper fixing occurred in some cases. The reason therefor would be considered that the thickness of the base layer 251 of the fixing film 25 is large and thus a thermal conduction property is insufficient.

Thus, in the constitutions of the comparison examples 1 and 2, it becomes difficult to compatibly realize the fixing property and the durability, so that there is a possibility that it becomes difficult to compatibly realize the lifetime elongation and the speed-up.

On the other hand, in this embodiment, throughout the printing of 200 K sheets, the problem relating to the fixing property and the durability did not occur. Thus, in the constitution of this embodiment, the lifetime elongation and the speed-up can be compatibly realized.

As described above, in this embodiment, the heating apparatus (fixing device) 130 includes the rotatable flexible endless film 25, the guide member 40 provided adjacent to the film 25 at the end portion with respect to the widthwise direction substantially perpendicular to the circumferential direction of the film 25, and the heating member 20 for imparting heat, via the film 25, to the image on the recording material contacting the outer surface of the rotating film 25. The restricting member 40 includes the restricting surface 40a for restricting movement of the film 25 in the widthwise direction in contact with the end portion of the film 25 with respect to the widthwise direction, and the film 25 includes the base layer 251 and the elastic layer 252 containing the thermal-conductive filler. Further, in this embodiment, the film 25 includes the base layer 251 provided with the base layer projected portion 25b positioned outside of the elastic layer 252 with respect to the widthwise direction at the end portion adjacent to the restricting member 40 with respect to the widthwise direction. Further, the width of the base layer projected portion 25b with respect to the widthwise direction may preferably be 0.1 mm or more. Incidentally, the width of the base layer projected portion 25b with respect to the widthwise direction may preferably be 10 mm or less. Particularly, in this embodiment, the restricting member 40 includes the guide surface 25b for restricting deformation of the film 25 toward an inner surface direction in contact with the inner surface of the end portion of the film 25 with respect to the widthwise direction. Further, in the constitution in which the restricting member 40 includes the guide surface 40b, the width of the base layer projected portion 25b with respect to the widthwise direction may preferably be 0.1 mm or more and may preferably be smaller than the width of the guide surface 40b with respect to the widthwise direction. Further, in this embodiment, the restricting member 40 is provided adjacent to each of the opposite end portions of the film 25 with respect to the widthwise direction, and the base layer projected portion 25b is provided at each of the opposite end portions of the film 25 with respect to the widthwise direction. Further, in this embodiment, the base layer projected portion 25b is provided over an entire region of the film 25 with respect to the circumferential direction. Here, in this embodiment, the base layer 251 is constituted principally by a resin material. Further, in this embodiment, the thermal-conductive filler is constituted by an inorganic material. For example, the thermal-conductive filler contains ceramic powder, metal oxide powder, or metal powder. Typically, the thermal-conductive filler contains alumina, metal silicon, silicon carbide, or zinc oxide.

Further, in this embodiment, the heating apparatus (device) 130 includes the roller 26 which includes the core shaft portion 261 disposed substantially in parallel to the above-described widthwise direction and the elastic member layer 262 provided around the core shaft portion 261 and which is rotatable in press-contact with the film 25.

In this embodiment, the constitution in which the base layer 251 is electrically grounded from the inner surface via the resistor was described, but a constitution in which a diode is provided may also be employed. In this case, there is a need to provide the diode so that a cathode side the diode is connected to the base layer 251 of the film 25. The purpose therefor is to prevent that the surface layer 253 of the fixing film 25 is charged up to the opposite polarity (positive in this embodiment) to the charge polarity of the toner and causes an offset. Further, in this embodiment, the roller 26 is electrically grounded from the core shaft portion 263 via the resistor and the diode. Incidentally, in this embodiment, the constitution in which the voltages are not applied to the fixing film 25 and the pressing roller 26 was employed, but a constitution in which the voltages are applied to these members may also be employed. In this case, the distance (width) W3 between the base layer projected portion 25b of the fixing film 25 and the surface layer 263 of the pressing roller 26 may desirably be set appropriately so that the creepage distance is ensured so as not to generate the electric discharge. Further, in this embodiment, at the end portion of the film 25 adjacent to the restricting member 40 with respect to the widthwise direction, the elastic layer 252 or the surface layer 253 of the film 25 is positioned outside the surface layer 263 of the roller 26 with respect to the widthwise direction of the film 25. In this embodiment, the heating apparatus 130 is the fixing device for fixing the image, formed on the recording material P with the toner, on the recording material P by heat of the heating member 20. Further, according to this embodiment, the image forming apparatus 100 including the image forming portion 10 for forming the image on the recording material P with the toner, and the above-described heating apparatus (fixing device) 130 is provided.

According to this embodiment, the occurrence of the inner surface abrasion of the fixing film 25 can be suppressed while enhancing the heat-conducting performance of the fixing film 25, so that it is possible to compatibly realizing the speed-up and the lifetime elongation. That is, according to this embodiment, the abrasion of the fixing film 25 including the elastic layer 252 containing the thermal-conductive filler is suppressed, so that the lifetime elongation can be realized.

### Embodiment 2

Next, another embodiment of the present invention will be described. Basic structure and constitution of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 are represented by the same reference numerals or symbols, and will be omitted from detailed description.

This embodiment is principally different from the embodiment 1 in structure of the flange 40. A constitution of the fixing film 25 is similar to the constitution of the fixing film 25 in the embodiment 1. In this embodiment, the flange 40 is not provided with the guide surface 40b. That is, in this embodiment, the flange 40 contacts the end portion of the fixing film 25 with respect to the widthwise direction only by the restricting surface 40a. Thus, even in the case where the flange 40 is not provided with the guide surface 40a, abrasion of the end portion of the base layer 251 of the fixing film 25 is promoted by the thermal-conductive filler contained in the elastic layer 252 of the fixing film in some instances. As a result, the length of the fixing film 25 with respect to the widthwise direction becomes short, and rotation of the fixing film 25 becomes unstable, so that there is a possibility that improper feeding of the recording material P occurs.

FIG. 8 is a schematic sectional side view of a neighborhood of the right-side flange 40 in part (a) of FIG. 3 as viewed from an upstream side of the feeding direction of the recording material P in a fixing device 130 of a comparison example in which a fixing film 25 does not have a constitution in accordance with the present invention. In the figure, a cross section of the fixing film 25 along the widthwise direction and a side surface of the flange 40 are shown. Incidentally FIG. 8 shows a state in which the fixing film 25 causes a shift in a rightward direction in part (a) of FIG. 3 and contacts the restricting surface 40a of the right-side flange 40 in part (a) of FIG. 3. Further, also, as regards the comparison example, elements corresponding to those of this embodiment will be described by adding the same reference numerals or symbols. In this comparison example, the flange 40 does not include the guide surface 40b. At the end portion of the fixing film 25 with respect to the widthwise direction, the elastic layer 252 of the fixing film 25 slides and rotates on the restricting surface 40a of the flange 40. Then, the thermal-conductive filler contained in the elastic layer 252 of the fixing film 25 is abraded. This thermal-conductive filler is interposed between the base layer 251 of the fixing film 25 and the restricting surface 40a of the flange 40 in the sliding region B, so that abrasion of the end surface of the base layer 251 of the fixing film 251 is promoted.

Part (a) of FIG. 9 is a schematic sectional side view of a neighborhood of the right-side flange 40 of the fixing device 130 in this embodiment in part (a) of FIG. 3 as viewed from the upstream side of the feeding direction of the recording material P. In the figure, a cross section of the fixing film 25 along the widthwise direction and a side surface of the flange 40 are shown. Incidentally, part (a) of FIG. 9 shows a state in which a shift of the fixing film 25 in the rightward direction in part (a) of FIG. 3 occurs and the fixing film 25 contacts the restricting surface 40a of the light-side flange 40 in part (a) of FIG. 3. In this embodiment, the flange 40 does not include the guide surface 40b. Further, in this embodiment, at the end portion of the fixing film 25 with respect to the widthwise direction, only the base layer 251 of the fixing film 25 and the restricting surface 40a of the flange 40 are in contact with each other. That is, in the constitution of the comparison example shown in is FIG. 8, the base layer 251 and the elastic layer 252 of the fixing film 25 contact the restricting surface 40a of the flange 40. On the other hand, in the constitution of this embodiment shown in part (a) of FIG. 9, only the base layer 251 of the base layer projected portion 25b of the fixing film 25 contacts the restricting surface 40a of the flange 40. In this embodiment, the elastic layer 252 of the fixing film 25 and the restricting surface 40a of the flange 40 does not slide with each other, and therefore, the thermal-conductive filler is not abraded, so that the base layer 251 of the fixing film 25 is not worn from the end surface.

Part (b) of FIG. 9 is a sectional side view, similar to part (a) of FIG. 9, showing a constitution of a modified embodiment of this embodiment. In the constitution of part (b) of FIG. 9, similarly as in the constitution of part (a) of FIG. 9, the flange 40 does not include the guide surface 40b. However, in the constitution of part (b) of FIG. 9, the flange 40 has a cap shape such that a surface layer guide surface 40d capable of contacting the surface layer 253 of the fixing film 25. Also, in the case of such a cap-shaped flange 40, an effect similar to the effect of this embodiment can be obtained.

As described above, the present invention is also applicable to the constitution in which the flange 40 which does not include the guide surface 40b, and the effect similar to the effect of the embodiment 1 can be obtained.

### Embodiment 3

Next, a third embodiment of the present invention will be described. Basic structure and constitution of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 are represented by the same reference numerals or symbols, and will be omitted from detailed description.

This embodiment is principally different from the embodiment 1 in structure of the fixing film 25. A characteristic feature of the fixing film 25 of this embodiment is such that a surface of the base layer projected portion 25b formed at each of the opposite end portions of the fixing film 25 has been subjected to an insulating treatment (process). By employing this constitution, an effect such that the heating apparatus can be downsized.

The constitution of the fixing film 25 is shown in parts (a) to (d) of FIG. 10. A characteristic feature of the fixing film 25 of this embodiment is such that on the surface of the base layer projected portion 25b, insulating films 254l and 254r are formed. A material of the insulating films 254 (254l and 254r) may only be required to be a heat-resistant thin film having an insulating property, and for example, a heat-resistant resin material such as polyimide or polyamideimide can be used. Further, it is more desirable that the material has a parting property from the toner T. As a material forming the heat-resistant thin film having the insulating property and the parting property, a fluorine-containing resin material such as FEP, PTFE or PFA can be used. In this embodiment, PFA which is the fluorine-containing resin material was employed. As method of preparing the insulating coating film, a thin film forming means can be used, but in this embodiment, the insulating coating film was prepared by the following means. That is, an adhesive was applied onto the base layer 251 of the base layer projected portion 25b, and after drying, a dispersion in which PFA was dissolved in a solvent was applied onto the surface of the base layer 251 by dipping. Thereafter, the dispersion was dried and baked, so that insulating coating films (insulating films) 254l and 254r were formed.

A positional relationship between the fixing film 25 and the pressing roller 26 at their end portions in this embodiment is shown in part (a) of FIG. 11. A region in which the surface layer 263 of the pressing roller 26 and the base layer projected portion 25b of the fixing film 25 are adjacent to each other is referred to as an adjacent region C. In the adjacent region C in this embodiment, with respect to the widthwise direction W, setting is made so that the surface layer 263 of the pressing roller 26 and the base layer projected portion 25b of the fixing film 25 overlap with each other by a width w4. Incidentally, in FIG. 11, structures of respective members (layers) are schematically shown, and therefore, although the surface layer 263 of the pressing roller 26 and the insulating film 254r are seen so as to be spatially separated from each other in the adjacent region C, these are in contact with each other in actuality. The reason therefor is because thicknesses of the elastic layer 252 and the surface layer 253 of the fixing film 25 are 270 μm and 25 μm, respectively, which are thin, and in addition, the elastic layer of the pressing roller 26 is deformed softly, and therefore, also in the adjacent region C, the pressing roller 6 is deformed and contacts the insulating film 254r of the fixing film 25.

In this embodiment, even when setting is made so that the surface layer 263 of the pressing roller 26 and the base layer projected portion 25b overlap with each other, leakage of a transfer current does not occur. The reason therefor is as follows. The fixing film 25 of this embodiment includes the insulating film 254 at the base layer projected portion 25b as described above. For this reason, even in a constitution in which the base layer projected portion 25b of the fixing film 25 and the surface layer 263 of the pressing roller 26 overlap with each other with respect to the widthwise direction W, the leakage of the transfer current does not occur. Incidentally, the width w4 in this embodiment was set at 0.5 mm. Further, the thickness of the insulating film 254 should be determined so as to ensure the insulating property even when the abrasion due to long-term use is taken into consideration, and may desirably be 1 μm or more, further desirably be 3 μm or more. In this embodiment, the thickness of the insulating film 254 was set at 10 μm.

By employing the above-described constitution, the fixing film 25 of this embodiment can be shortened in full length with respect to the widthwise direction of the widthwise direction of the fixing film 25 than the fixing film 25 in the constitution of the fixing device of the embodiment 1. A specific shortening width will be described using parts (b) and (c) of FIG. 1. Part (b) of FIG. 11 is a schematic sectional side view of the fixing device of this embodiment at the end portion with respect to the widthwise direction and part (c) of FIG. 11 is a schematic sectional side view of the fixing device of the embodiment 1 at the end portion with respect to the widthwise direction. In these figures, the fixing devices are illustrated so that positions of the end portions of the elastic layers 262 of the pressing rollers 26 with respect to the widthwise direction are the same. The position of the end portion of the elastic layer 262 of the pressing roller 26 should be determined depending on a maximum image forming width and a maximum paper (sheet) size capable of being passed through the fixing device. Accordingly, from part (c) of FIG. 11, the width of the fixing film 25 in the embodiment 1 is set so as to be longer than the elastic layer 262 of the pressing roller 26 by w3. On the other hand, in the fixing device of this embodiment (embodiment 3), the width of the fixing film 25 can be set so as to be shorter than the elastic layer 262 of the pressing roller 26 by w4. That is, the fixing film 25 of this embodiment can be made shorter than the fixing film 25 of the embodiment 1 by (w3+w4) on one side. As a result, it is possible to downsize the fixing film, by extension to the fixing device.

The fixing film 25 of this embodiment employed the constitution in which the surface of the base layer 251 at the base layer projected portion 25b is coated with the insulating film 254, but as shown in part (b) of FIG. 10, it is also possible to employ a constitution such that a cross section of the elastic layer 252 is coated. This constitution is an effective constitution, for example, in the case where a resistance of the elastic layer 252 of the fixing film 25 is low, such as in the case where a metal filler is contained in the elastic layer 252.

Further, another form of the fixing film 25 in this embodiment is shown in part (c) of FIG. 10. The fixing film 25 in part (c) of FIG. 10 has a constitution in which at the elastic layer projected portions 25b of the opposite end portions, the surface layer 253 is bonded to the base layer 251. The surface layer 253 uses the PFA tube similarly as in the embodiment 1, and is formed of a material having the insulating property and the parting property from the toner T.

An example of a manufacturing method of the above-described film will be described. A constitution in which the surface layer 253 is longer than the elastic layer 252 with respect to the widthwise direction W. Further, the adhesive is applied onto the base layer 251 at the base layer projected portions 25b, so that the surface layer 253 and the base layer 251 are bonded to each other.

An effect of this embodiment can be achieved when the insulating property between the base layer projected portion 25b and the surface layer 263 of the pressing roller 26 is ensured. For example, even in a constitution in which the base layer 254 has a two-layer structure and in which the base layer 251 has the insulating property on a front surface side at the base layer projected portion 25b, a similar effect can be achieved. Further, as shown in part (d) of FIG. 10, a constitution in which side surfaces of the base layer 251 are coated with the insulating film 254 may also be employed.

### Other Embodiments

As described above, the present invention was described in accordance with specific embodiments, but is not limited to the above-described embodiments.

For example, the heating apparatus is typically the fixing device for fixing the unfixed toner image on the recording material, but may also be a device for controlling glossiness by re-heating the recording material on which the toner image is fixed, or the like device.

Further, in the above-described embodiments, the restricting members were provided adjacent to the opposite end portions of the film with respect to the widthwise direction, and the base layer projected portions were provided on the opposite end portions of the film with respect to the widthwise direction, but the present invention is not limited to such an embodiment. For example, in a constitution in which the shift direction of the film is restricted to a predetermined direction toward a predetermined end portion side or in the like constitution, each of the restricting members and each of the base layer projected portions may also be provided only on the end portion side of the film with respect to the widthwise direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2020-210844 filed on Dec. 18, 2020 and 2021-178381 filed on Oct. 29, 2021, which are hereby incorporated by reference herein in their entirety.

What is claimed is:

1. A heating apparatus for heating an image on a recording material, comprising:
an endless film rotatable while contacting the recording material on which the image is formed, said film including a base layer made of a resin material and an elastic layer provided around said base layer;
a heating member configured to heat said film; and
a restricting member provided adjacent to an end portion of said film with respect to a widthwise direction perpendicular to a circumferential direction of said film, said restricting member including a restricting surface for restricting movement of said film in the widthwise direction by receiving an end surface of said film with respect to the widthwise direction when said film is moved in the widthwise direction,
wherein said elastic layer contains a thermal-conductive filler,
wherein said base layer includes a projected portion projected from said elastic layer in the widthwise direction, and
wherein the movement of said film in the widthwise direction is restricted by contact of said projected portion with said restricting surface.

2. A heating apparatus according to claim 1, wherein a width of said projected portion with respect to the widthwise direction is 0.1 mm or more and 10 mm or less.

3. A heating apparatus according to claim 1, wherein said restricting member includes a guiding surface for restricting deformation of said film toward an inner surface direction in contact with an inner surface of said film at the end portion with respect to the widthwise direction.

4. A heating apparatus according to claim 3, wherein a width of said projected portion with respect to the widthwise direction is 0.1 mm or more and is narrower than a width of said guiding surface with respect to the widthwise direction.

5. A heating apparatus according to claim 1, wherein said restricting member is provided adjacent to each of opposite end portions of said film with respect to the widthwise direction, and said projected portion is provided at each of the opposite end portions of said film with respect to the widthwise direction.

6. A heating apparatus according to claim 1, wherein said thermal-conductive filler is constituted by an inorganic material.

7. A heating apparatus according to claim 6, wherein said thermal-conductive filler contains at least one of ceramic powder, metal oxide powder, and metal powder.

8. A heating apparatus according to claim 6, wherein said thermal-conductive filler contains at least one of alumina, metal silicon, silicon carbide, and zinc oxide.

9. A heating apparatus according to claim 1, further comprising a roller which includes a core shaft portion provided substantially parallel to the widthwise direction and an elastic member layer provided around said core shaft portion and which is rotatable in press-contact with an outer peripheral surface of said film,
wherein said heating member is provided in an inside space of said film, and forms a nip where the recording material is nipped and fed by said heating member and said roller via said film.

10. A heating apparatus according to claim 9, wherein said base layer of said film is electrically grounded from an inner surface of said film, and
wherein with respect to the widthwise direction, an end surface of said elastic layer is positioned outside a surface layer of said roller.

11. A heating apparatus according to claim 9, wherein said projected portion of said film is subjected to an insulation process at a surface thereof.

12. A heating apparatus according to claim 11, wherein said projected portion is subjected to the insulation process by being coated with an insulating resin material.

13. A heating apparatus according to claim 11, wherein said film includes a surface layer around said elastic layer, and
wherein said projected portion is subjected to the insulation process by being coated with said surface layer.

14. An image forming apparatus comprising:
an image forming portion configured to form an image on a recording material with toner, and
a heating apparatus according to claim 1.

15. An endless film for use with a heating apparatus for heating an image on a recording material, said endless film comprising:
a base layer made of a resin material; and
an elastic layer provided around said base layer,
wherein said elastic layer contains a thermal-conductive filler, and
wherein said base layer includes a projected portion projected from said elastic layer in a widthwise direction perpendicular to a circumferential direction of said film.

16. An endless film according to claim 15, wherein a width of said projected portion with respect to the widthwise direction is 0.1 mm or more and 10 mm or less.

17. An endless film according to claim 15, wherein said thermal-conductive filler contains at least one of ceramic powder, metal oxide powder, and metal powder.

18. An endless film according to claim 15, wherein said thermal-conductive filler contains at least one of alumina, metal silicon, silicon carbide, and zinc oxide.

19. A heating apparatus according to claim 15, wherein said projected portion of said film is subjected to an insulation process at a surface thereof.

20. A heating apparatus according to claim 19, wherein said projected portion is subjected to the insulation process by being coated with an insulating resin material.

21. A heating apparatus according to claim 19, wherein said film includes a surface layer around said elastic layer, and
wherein said projected portion is subjected to the insulation process by being coated with said surface layer.
